(19) United States
(12) Patent Application Publication
(10) Pub. No.: US 2013/0314784 A1
(43) Pub. Date: Nov. 28, 2013

(54) GRATING-BASED POLARIZERS AND OPTICAL ISOLATORS

(71) Applicants: David A Fattal, Mountain View, CA (US); Marco Fiorentino, Mountain View, CA (US); Raymond G. Beausoleil, Redmond, WA (US)

(72) Inventors: David A Fattal, Mountain View, CA (US); Marco Fiorentino, Mountain View, CA (US); Raymond G. Beausoleil, Redmond, WA (US)

(21) Appl. No.: 13/984,738

(22) PCT Filed: Feb. 10, 2011
(86) PCT No.: PCT/US2011/024303

§ 371 Date: Aug. 9, 2013

(51) Int. Cl. G02F 1/09; G02B 5/30

(52) U.S. Cl. CPC G02F 1/093; G02B 5/3083
USPC 359/484.04; 359/489.08

(57) ABSTRACT

Optical polarizers and optical isolators and systems that incorporate the optical polarizers and isolators are disclosed. In one aspect, an optical isolator includes a Faraday crystal with a first surface and a second surface opposite the first surface, a first one-dimensional sub-wavelength grating disposed on the first surface, and a second one-dimensional sub-wavelength grating disposed on the second surface. The isolator is to receive a first input beam of light on the first grating and output a polarized first output beam of light through the second grating approximately parallel to the first input beam. The isolator is to also receive a second input beam of light on the second grating and output a polarized second output beam of light through the first grating with the second output beam offset from the second input beam.

### TECHNICAL FIELD

This disclosure relates to polarizers and optical isolators.

### BACKGROUND

A polarizer is a device whose input is typically natural or unpolarized light and whose output is polarized light. Polarizers can be used in a variety of instruments as polarizing filters. Common commercially available polarizers include birefringent filters and thin-film polarizers. The most commonly used birefringent filters are Glan-type polarizers, including Glan-Taylor and Glan-laser prisms. These prisms are typically made of two right-angled prisms of calcite, or another birefringent material, which are positioned adjacent to one another along their long faces and separated by an air gap. The two right triangle prisms are cut and oriented so that the optic axes of the two prisms are perpendicular. The polarization components of light entering the Glan-type prisms are referred to as s-polarized and p-polarized light. S-polarized light refers to the electric field component directed perpendicular to the plane of incidence, and p-polarized light refers to the electric field component directed parallel to the plane of incidence. Total internal reflection of s-polarized light at the air gap ensures that only p-polarized light is transmitted by the filter. While p-polarized light is often transmitted with a transmittance of approximately 100%, s-polarized light typically is not.

On the other hand, thin-film polarizers are composed of an optical coating disposed on a surface of a glass substrate. The substrate can either be a glass plate, which is inserted into a beam of unpolarized light at a particular angle, or the substrate can be a wedge-shaped glass prism cemented to a second wedge to form a cube with the coating disposed between the adjoining long faces of the wedges. The composition of the coating is selected to create interference effects that enable a thin-film polarizer to operate as a beam-splitting polarizer. Thin-film polarizers typically do not perform as well as Glan-type polarizers, but thin-film polarizers are less expensive to fabricate and provide two orthogonally polarized beams.

Although remarkable progress has been made in the development of low-power, small-scale photonic devices that can be integrated with, and fabricated on the same platform as, microelectronic devices, efforts to integrate typical birefringent filters and thin-film polarizers with microelectronic devices have been hampered, because these devices are considerably more expensive, bulkier, and time consuming to fabricate than typical microelectronic and other photonic devices. As a result, the computer industry continues to seek smaller, low-cost polarizers that can be integrated with typical microelectronic and photonic devices.

### BRIEF DESCRIPTION OF THE DRAWINGS

FIGS. 1A-1B show isometric and magnified views, respectively, of an example optical polarizer.

FIG. 2 shows an isometric view of an example polarizer interacting with an incident ray of light.

FIG. 3 shows a transmittance plot of TE and TM polarization components of incident light versus a range of wavelengths for an example polarizer.

FIGS. 4A-4B show isometric and exploded isometric views, respectively, of an example optical isolator.

FIG. 5 shows an isometric view of an example optical isolator and includes magnified isometric views of a first and a second sub-wavelength grating.

FIGS. 6A-6B show an exploded isometric and top view of an example optical isolator interacting with TE and TM polarization components of a primary beam of light.

FIGS. 7A-7B show an exploded isometric and top view of an example optical isolator interacting with TE and TM polarization components of a secondary beam of light.

FIGS. 8A-8B show a schematic representation of an example channel source.

### DETAILED DESCRIPTION

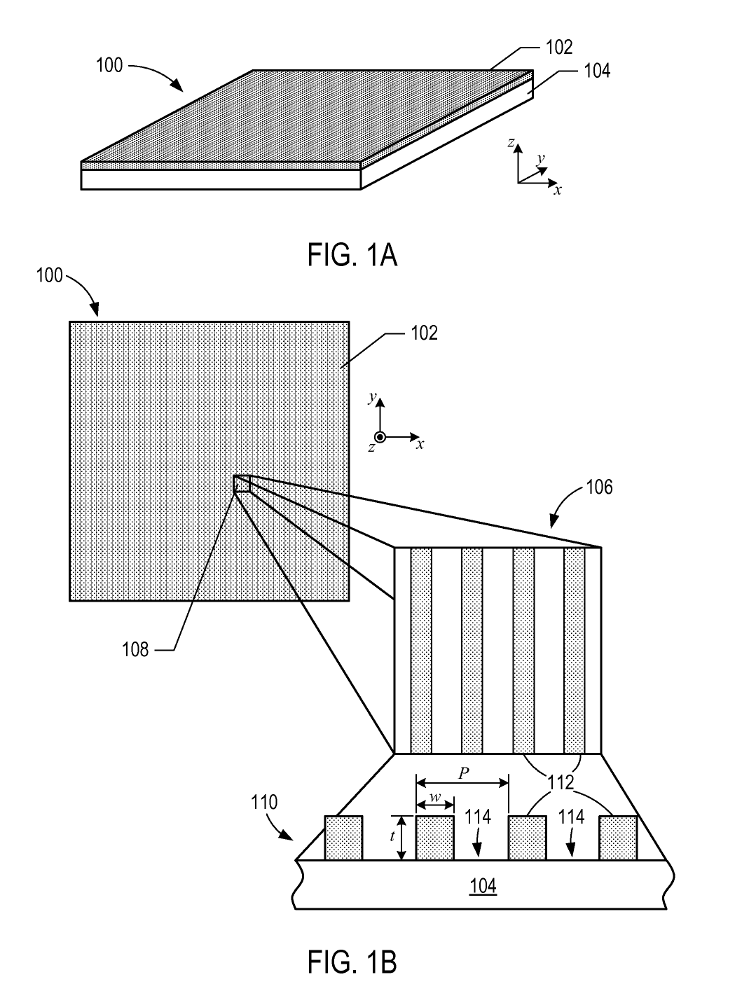

This disclosure is directed to optical polarizers and isolators and systems that incorporate the optical isolators. FIG. 1A shows an isometric view of an example optical polarizer 100. The polarizer 100 includes a planar, sub-wavelength grating (“SWG”) 102 disposed on a substrate 104. FIG. 1B shows a top view of the polarizer 100 and includes a magnified view 106 of a region 108 and a magnified end-on view 110 of the same region 108. The magnified views 106 and 110 reveal that the SWG 102 comprises regularly spaced wire-like portions of the SWG 102 material called “lines” 112. The lines 112 extend in the y-direction with a width w, thickness t, and are periodically spaced in the x-direction with a period P. The lines 112 are separated by grooves 114 that expose the surface of the substrate 104.

The SWG 102 is a strong or high-contrast SWG because of the relatively high contrast between the refractive index of the material comprising the SWG 102 and the refractive index of the substrate 104. For example, the SWG 102 can be composed of a single elemental semiconductor, such as silicon (“Si”) and germanium (“Ge”), or a compound semiconductor, such as III-V compound semiconductor, where Roman numerals III and V represent elements in the IIIa and Va columns of the Periodic Table of the Elements. Compound semiconductors can be composed of column IIIa elements, such as aluminum (“Al”), gallium (“Ga”), and indium (“In”), in combination with column Va elements, such as nitrogen (“N”), phosphorus (“P”), arsenic (“As”), and antimony (“Sb”). Compound semiconductors can also be further classified according to the relative quantities of III and V elements. For example, binary semiconductor compounds include semiconductors with empirical formulas GaAs, InP, InAs, and GaP; ternary compound semiconductors include semiconductors with empirical formula GaAs_{y}P_{1-y}, where y ranges from greater than 0 to less than 1; and quaternary compound semiconductors include semiconductors with empirical formula InₓGa₁₋ₓAs_{y}P_{1-y}, where both x and y independently range from greater than 0 to less than 1. Other types of suitable compound semiconductors include II-VI materials, where II and VI represent elements in the IIb and VIa columns of the periodic table. For example, CdSe, ZnSe, ZnS, and ZnO are empirical formulas of exemplary binary II-VI compound semiconductors. The substrate 104 can be composed of suitable transparent material, such as quartz, silicon dioxide (‘SiO₂”), aluminum oxide (“Al₃O₂”), or a transparent polymer.

The SWG 102 is a “periodic” SWG. In other words, the SWG 102 is configured with the same period spacing P, line width w, and thickness t throughout. The SWG 102 is also referred to as a sub-wavelength grating because the line width w and period P are less than the wavelength λ of the light for which the grating is configured to interact. For example, the lines widths can range from approximately 10 nm to approximately 300 nm and the periods can range from approximately 20 nm to approximately 1 μm depending on the wavelength λ of the incident light.

The polarizers and isolators are compact and can be fabricated with many of the same techniques used to fabricate CMOS microelectronic. For example, a polarizer can be formed by depositing a semiconductor layer on a substrate using wafer bonding or chemical or physical vapor deposition. The lines of the SWG 102 can be formed using photolithography, nanoimprint lithograph, or reactive-ion etching.

In order to design a SWG to interact with a particular wavelength of light as described in greater detail below, a property of Maxwell's equations that relates to a uniform scale transformation is used. In particular, consider a first one-dimensional periodic SWG configured with a particular line width w, line thickness t, and period P that has a particular complex reflection coefficient r₀ at a frees-space wavelength λ₀. A second SWG can be obtained with approximately the same reflection coefficient, but for a different wavelength λ, by fabricating the second SWG with a line width αw, line thickness αt, and period αP, where α=λ/λ₀ is a scale factor. As a result, the second SWG has a reflection coefficient r(λ)=r₀(λ/α)=r₀(λ₀).

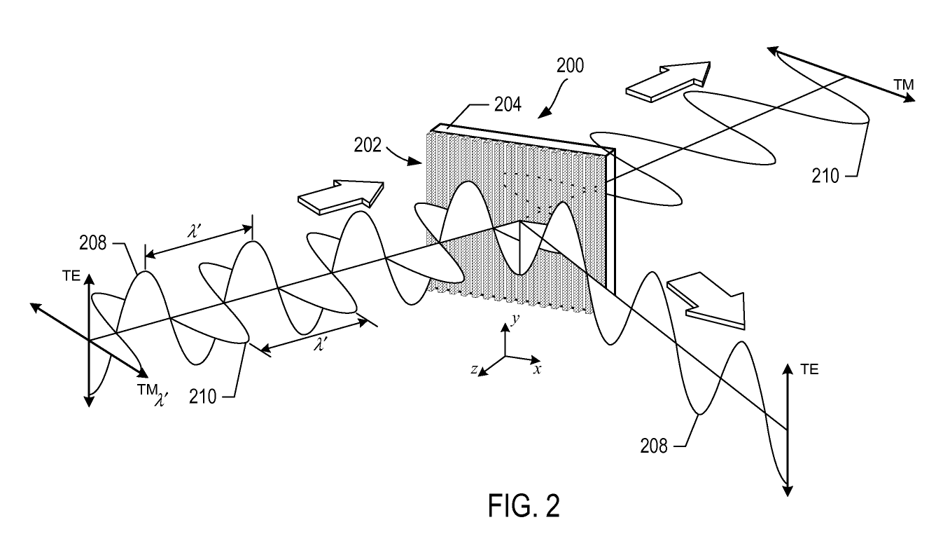

FIG. 2 shows an isometric view of an example polarizer 200 interacting with an incident ray of light 206. The polarizer 200 includes a one-dimensional, periodic SWG 202 disposed on a substrate 204. The ray of light 206 has a wavelength λ′ and strikes the SWG 202 with a non-zero angle of incidence. As shown in the example of FIG. 2, the light 206 can be decomposed into a TE polarization component 208 and a TM polarization component 210. The TE polarization 208 is represented by the sinusoidal electric field component of a first electromagnetic wave with the electric field component directed parallel to the lines of the SWG 202, and the TM polarization 210 is represented by the sinusoidal electric field component of a second electromagnetic wave with the electric field component directed perpendicular to the lines of the SWG 202. The SWG 202 is resonant with the TE polarization by configuring the SWG a thickness T≈λ′/mn, where m is positive number, and n is the SWG 202 material effective index of refraction at the wavelength λ′. For example, m typically has the value “4” for many suitable SWG materials. At resonance, the TE polarization 208 is reflected with approximately 100% reflectance, while the TM polarization 210 is mostly transmitted.

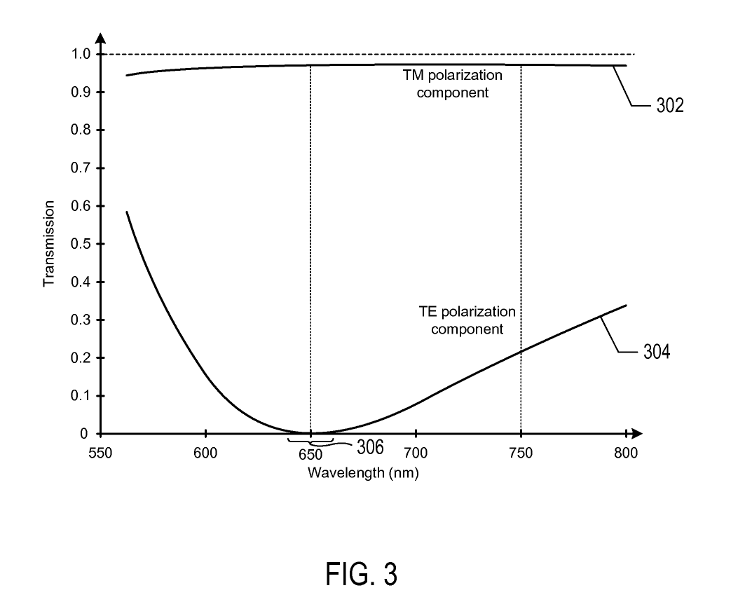

FIG. 3 shows simulation results in the form of a transmittance plot versus a range of wavelengths for an example polarizer configured to establish a strong resonance with the TE polarization of light with a wavelength of approximately 650 nm. The polarizer includes a one-dimensional, periodic Si SWG disposed on a quartz substrate with an air/Si fraction of 70/30%. In other words, the SWG has a period of 385 nm, a line width of 115 nm, and a line thickness of 50 nm. Note that the thickness of the Si SWG is extremely small at approximately 50 nm. In other words, the thickness of of the Si SWG can be determined by t≈λ′/(4·3.5)=650/13, where the effective refractive index of Si interacting with light at a wavelength of 650 nm is approximately 3.5. The simulation results are represented by curves 302 and 304, which were produced using the Rigorous Coupled Wave Analysis (“RCWA”) algorithm multimode transfer matrix. Curve 302 reveals that nearly the entire TM polarization is transmitted for incident light over wavelengths ranging from approximately 550 nm to approximately 800 nm. On the other hand, curve 304 reveals that for incident light with a wavelength of approximately 650 nm nearly the entire TE polarization is reflected. In other words, the transmittance is approximately “0” for incident light with the wavelength 650 nm. Curve 304 also reveals an interval 306 of wavelengths ranging from approximately 640 nm to approximately 660 nm in which incident light has a transmittance approaching zero. For light with wavelengths outside of the interval 306, the curve 304 indicates that the TE polarization has partial resonance with the SWG, which decreases the farther the wavelengths of the incident light are away from the interval 306. For example, for incident light with a wavelength of 750 nm, the TM polarization is transmitted with a transmittance of approximately “1,” while the TE polarization has only partial resonance with the SWG corresponding to a transmittance of approximately 0.2 and a reflectance of approximately 0.8.

The polarizers described above can be combined with a Faraday crystal to form an optical isolator. The optical isolators disclosed herein are polarization dependent isolators that can receive a beam of light incident in one direction and output an output beam of light with a particular polarization and substantially no beam offset from the incident beam. On the other hand, when the same optical isolators receive a beam of light incident from the opposite direction, an output beam is also produced with a particular polarization but the output beam is offset from the incident beam.

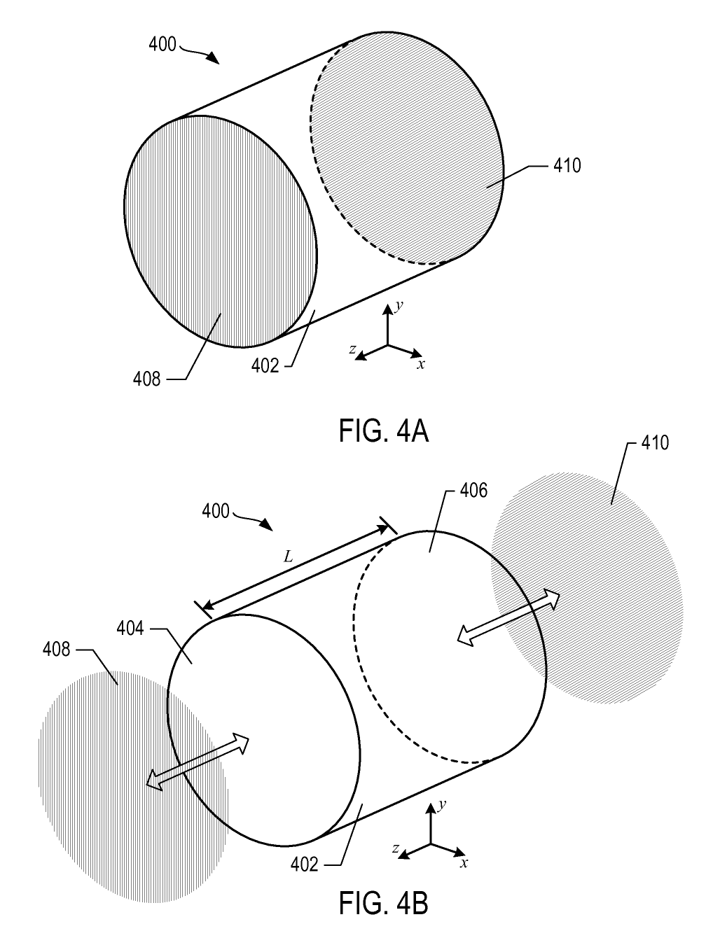

FIGS. 4A-4B show isometric and exploded isometric views, respectively, of an example optical isolator 400. The isolator 400 includes a Faraday crystal 402 with a first planar surface 404 and a second planar surface 406 located opposite the first surface 404 and separated by a distance L. The isolator 400 also includes a first SWG 408 disposed on the first surface 404 and a second SWG 410 disposed on the second surface 406.

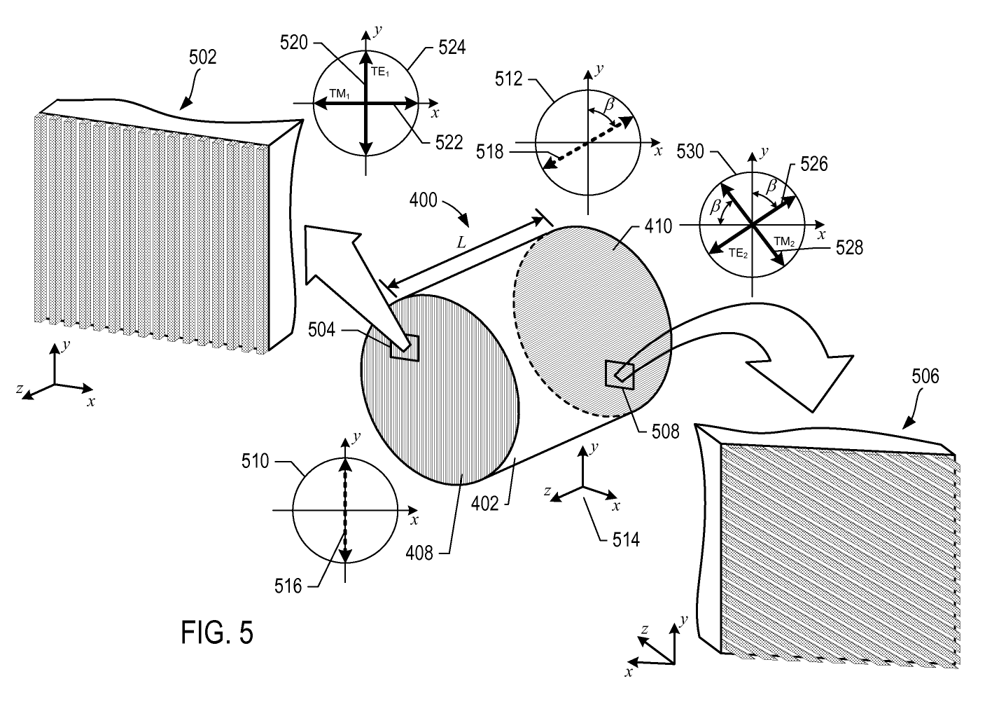

FIG. 5 shows an isometric view of the example optical isolator 400 and includes a magnified isometric view 502 of a portion 504 of the first SWG 408 and a magnified isometric view 506 of a portion 508 of the second SWG 410. FIG. 5 also includes a first unit circle 510 associated with the first SWG 408 and a second unit circle 512 associated with the second SWG 410. The unit circles 510 and 512 lie within the xy-plane of a Cartesian coordinate system 514 and represent the relative angular orientations of the lines comprising the first and second SWGs 408 and 410. In particular, double-headed dashed arrow 516 indicates that the lines comprising the SWG 408 are directed parallel to the y-axis, and double-headed dashed arrow 518 indicates that the lines comprising the SWG 410 have a non-zero angle of orientation β with respect to the lines comprising the SWG 408.

The SWGs 408 and 410 are configured to operate as polarizers for incident light with a particular wavelength, as described above in the example of FIG. 3. A first beam of light incident on the SWG 408 can be decomposed into a TE₁ polarization with the electric field component directed parallel to the lines of the SWG 408 and a TM₁ polarization with the electric field component directed perpendicular to the lines of the SWG 408. The TE₁ polarization is represented by double-headed arrow 520 and the TM₁ polarization is represented by double-headed arrow 522 in a unit circle 524. A second beam of light incident on the SWG 410 can be decomposed into a TE₂ polarization with the electric field component directed parallel to the lines of the SWG 410 and a TM₂ polarization with the electric field component directed perpendicular to the lines of the SWG 410. The TE₂ polarization is represented by double-headed arrow 526 and the TM₂ polarization is represented by double-headed arrow 528 in a unit circle 530.

The Faraday crystal 402 is shaped and oriented to rotate the polarization of linear polarized light input to the crystal 402 when a magnetic field of an appropriate magnitude and polarity is applied. In particular, the plane of linearly polarized light propagating through the crystal 402 is rotated through the angle β when a magnetic field is applied parallel to the propagation direction. The angle of rotation is given by:

β=VBd

where β is the angle of rotation, B is the magnetic flux density in the direction of propagation, d is the length of the propagation path where the light interacts with the magnetic field, and V is the Verdet proportionality constant for the crystal 402. The Verdet constant V varies with the wavelength and temperature of the crystal 402 and is tabulated for various materials. Examples of suitable Faraday crystals include glasses such as MOS-4, MOS-10, and terbium gallium garnet (“Tb₃Ga₅O₁₂”)

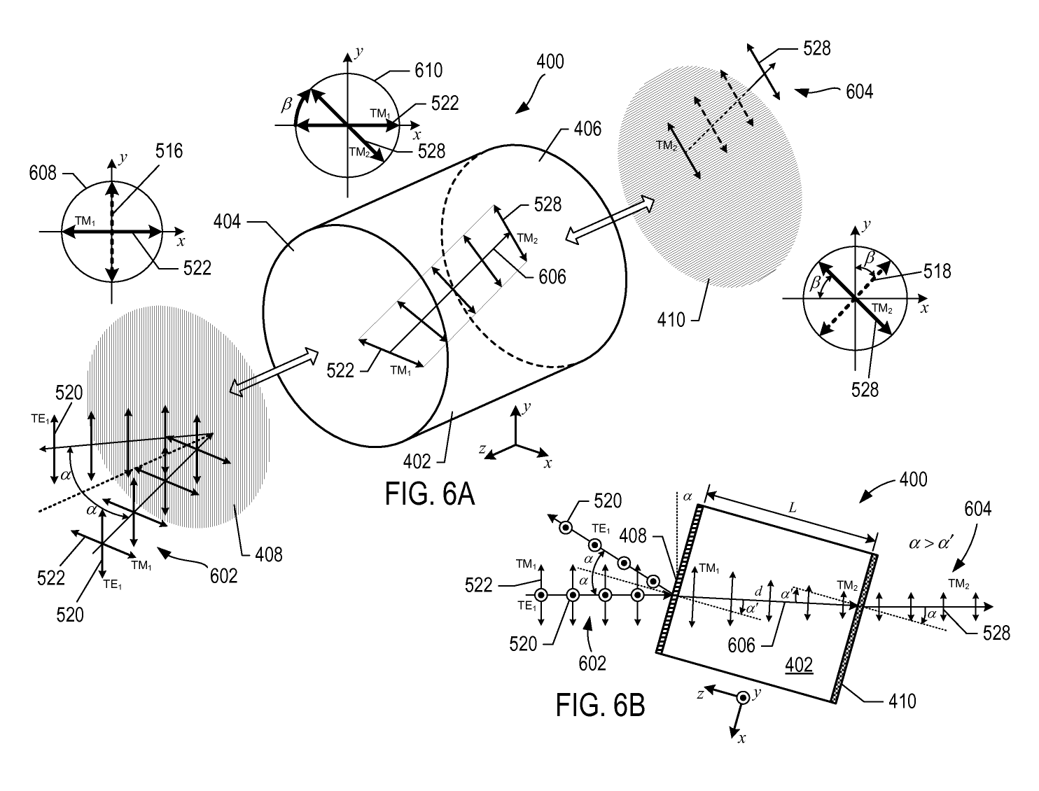

FIGS. 6A-6B show an exploded isometric view and a view along the y-axix of the isolator 400. A primary beam of light 600 is incident on the SWG 408 with a non-zero angle of incidence α and is decomposed into a combination of TE₁ polarization 520 and TM₁ polarization 522. The line width, thickness, period and material comprising the SWGs 408 and 410 are selected to have strong resonance with the wavelength of the primary beam 602, as described above with reference to FIG. 3. As a result, the TE₁ polarization 520 is reflected with a high reflectance of approximately “1” and the TM₁ polarization 522 is transmitted into the crystal 402 with a high transmittance of approximately “1.” As the TM₁ polarization 522 enters the crystal 402, as represented by unit circle 608, the wave propagates along a path 606 from the surface 404 toward the surface 406. An external magnetic field B is applied to the crystal 402 by a magnetic field source (not shown) and is directed approximately parallel to the path 606. The magnetic field source can be any permanent magnet such as samarium cobalt (e.g., SmCo₅). As the wave propagates along the path 606, the external magnetic field causes the wave to rotate through the angle β from TM₁ polarization 522 into TM₂ polarization 528, as represented by unit circle 610. As a result, the output beam 604 exits the isolator 400 with TM₂ polarization.

As shown in FIG. 6B, the output beam 604 exits the isolator 400 parallel to the primary beam 602 but the primary beam 602 is offset from the output beam 604 due to refraction at the first and second surfaces 404 and 406 of the crystal 402.

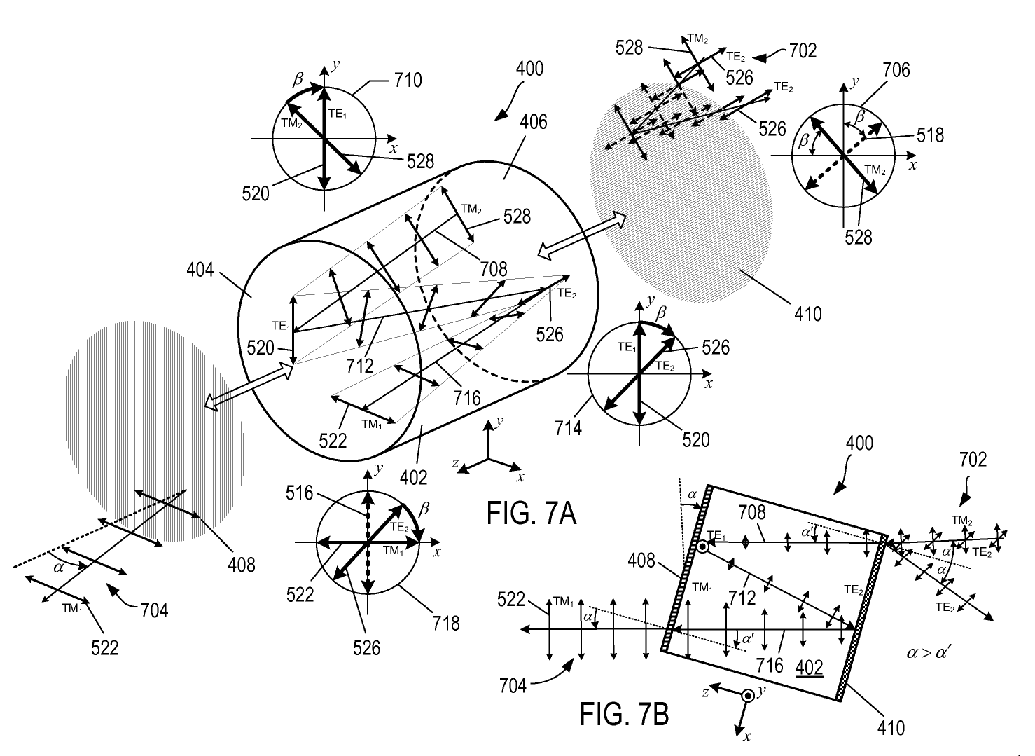

FIGS. 7A-7B also show an exploded isometric view and a view along the y-axis of the isolator 400. In FIG. 7, the isolator 400 receives a secondary beam 702 with a non-zero angle of incidence α and is decomposed into a combination of TE₂ polarization 526 and TM₂ polarization 528. The TE₂ polarization 526 is reflected with a high reflectance of approximately “1,” and the TM₂ polarization 528 is transmitted into the crystal 402 with a high transmittance of approximately “1.” As the TM₂ polarization 528 enters the crystal, as represented in by unit circle 706, the wave propagates along a path 708 from the surface 406 toward the surface 404. The external magnetic field B causes the wave to rotate through the angle β into the TE₁ polarization 520, as represented by unit circle 710. The SWG 408 reflects the TE₁ polarization 520 back into the crystal 402 to propagate along a path 712 and rotate through the angle β in reaching the surface 406 with TE₂ polarization 526, as represented by unit circle 714. Finally, the SWG 410 reflects the wave with TE₂ polarization 526 back into the crystal 402 to propagate along a path 716 and again rotate through the angle β in reaching the surface 404 with TM₁ polarization 522, as represented by unit circle 718. The return beam 704 exits the isolator 400 with TM₁ polarization.

As shown in FIG. 7B, the return beam 704 exits the isolator 400 parallel to the secondary beam 702 but the return beam 704 is offset from the secondary beam 702 because of refraction at the first and second surfaces 404 and 406 of the crystal 402 and because of two internal reflections with non-zero angles of reflection that take place within the crystal 402 at the SWGs 408 and 410.

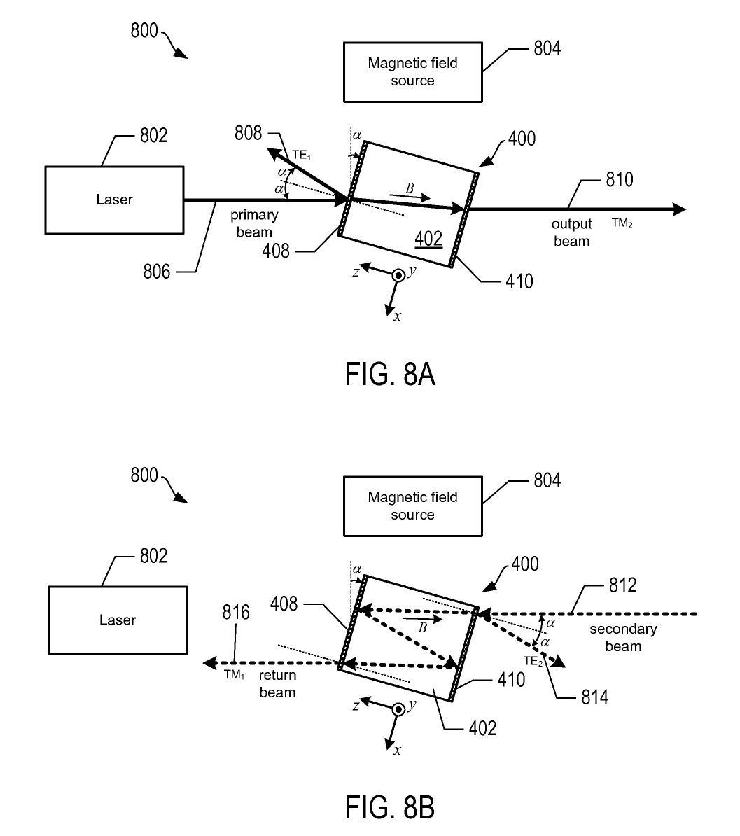

An optical isolator can be integrated in a channel source in order to allow transmission of a channel generated by a laser to be emitted in one direction and prevent unwanted feedback into the laser cavity. A “channel” can be a single wavelength of electromagnetic radiation or a narrow band of electromagnetic radiation centered about a particular wavelength. FIGS. 8A-8B show a schematic representation of an example channel source 800. The source 800 includes a laser 802, the optical isolator 400, and a magnetic field generator 804. In the example of FIG. 8A, the laser 802 generates a channel that is output as a primary beam of light 806. The SWGs 408 and 410 are configured to have strong resonance with the channel. As a result, a portion of the primary beam 806 is reflected with TE₁ polarization and an output beam 810 exits the isolator 400 with TM₂ polarization, as described above with reference to FIG. 6. On the other hand, in the example of FIG. 8B, a secondary beam 812 is directed back toward the laser 802 along substantially the same path as the output beam 810. The secondary beam 812 can be created by a modulator or other optical device that reflects at least a portion of the output beam 810 back toward the laser 802. The SWG 410 reflects a portion 814 of the secondary beam 812 with TE₂ polarization and a return beam 816 exits the isolator 400 with TM₁ polarization, as described above with reference to FIG. 7. The isolator 400 is angled so that the return beam 814 is not transmitted into the laser 802, preventing unwanted noise from being generated in the laser 802.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific examples are presented for purposes of illustration and description. They are not intended to be exhaustive of or to limit this disclosure to the precise forms described. Obviously, many modifications and variations are possible in view of the above teachings. The examples are shown and described in order to best explain the principles of this disclosure and practical applications, to thereby enable others skilled in the art to best utilize this disclosure and various examples with various modifications as are suited to the particular use contemplated. It is intended that the scope of this disclosure be defined by the following claims and their equivalents:

1. An optical isolator comprising:
a Faraday crystal with a first surface and a second surface opposite the first surface;
a first one-dimensional sub-wavelength grating disposed on the first surface; and
a second one-dimensional sub-wavelength grating disposed on the second surface, wherein the isolator is to receive a first input beam of light on the first grating and output a polarized first output beam of light through the second grating approximately parallel to the first input beam, and wherein the isolator is to receive a second input beam of light on the second grating and output a polarized second output beam of light through the first grating via two internal reflections within the crystal with the second output approximately parallel to and offset from the second input beam.

2. The isolator of claim 1, wherein the first grating further comprises a high contrast periodic grating and the second grating further comprise a high contrast periodic grating, and wherein lines of the first grating have a non-zero angle of orientation with respect to lines of the second grating.

3. The isolator of claim 1, wherein the first and second gratings each have a thickness proportional to the wavelengths of the first and second beams, respectively, divided by the grating material effective refractive index

4. The isolator of claim 1, further comprises the first grating to reflect a first portion of the first input beam and to transmit a second portion of the first input beam, the first portion having TE polarization with respect to lines of the first grating and the second portion having TM polarization with respect to lines of the first grating.

5. The isolator of claim 1, further comprises the second grating to reflect a first portion of the second input beam and to transmit a second portion of the second input beam, the first portion having TE polarization with respect to lines of the second grating and the second portion having TM polarization with respect to lines of the second grating.

6. The isolator of claim 1, wherein the isolator is to output the polarized first output beam further comprises the crystal to output the first output beam having TM polarization (528) with respect to lines of the second grating when a magnetic field is applied to the crystal.

7. The isolator of claim 1, wherein the isolator is to output the polarized second output beam further comprises the crystal to output the second output beam having TM polarization (522) with respect to lines of the first grating when a magnetic field is applied to the crystal.

8. A channel source comprising:
a laser to emit a primary beam of light;
a magnetic field source; and
an optical isolator disposed within the magnetic field generated by the magnetic field source and angled to receive the primary beam with a non-zero angle of incidence and output an output beam of light approximately parallel to the primary beam and to receive a secondary beam of light having the same wavelength as the primary beam and directed opposite the output beam and output a return beam via two internal reflections within the isolator and offset from the secondary beam to avoid interaction with the laser.

9. The source of claim 7, wherein the optical isolator to output the output beam further comprises the optical isolator to polarize the output beam, and wherein the optical isolator to output the return beam further comprises the optical isolator to polarize the return beam.

10. The source of claim 7, wherein the optical isolator further comprises:
a Faraday crystal with a first surface and a second surface opposite the first surface;
a first one-dimensional sub-wavelength grating disposed on the first surface; and
a second one-dimensional sub-wavelength grating disposed on the second surface, wherein lines of the first grating have a non-zero angle of orientation with respect to lines of the second grating, and wherein the first and second gratings each have a thickness proportional to the wavelength of the primary beam divided by the grating material effective refractive index.

11. The source of claim 10, wherein the first grating further comprises a high contrast periodic grating and the second grating further comprise a high contrast periodic grating.

12. The source of claim 7, wherein the isolator to output the output beam further comprises the isolator to polarize the output beam.

13. The source of claim 7, wherein the isolator to output the return beam further comprises the isolator to polarize the return beam.

14. A polarizer comprising:
a transparent substrate with a planar surface; and
a one-dimensional sub-wavelength grating disposed on the planar surface, the grating having a thickness proportional to a wavelength of light to interact with the grating divided by the grating material effective refractive index so that at least a portion of a TE polarization component of the light is reflected and a substantial portion of a TM polarization component of the light is transmitted.

15. The polarizer of claim 14, wherein the grating has a thickness determined by
$$t \approx \frac{λ}{m n}$$
where t represents the thickness of the grating, λ represents the wavelength of the light to interact with the grating, m is a positive number, and n is the effective refractive index of the grating material at the wavelength λ.
